(19) United States
(12) Patent Application Publication
(10) Pub. No.: US 2012/0196114 A1
(43) Pub. Date: Aug. 2, 2012

(54) Flexible and Transparent Conductive Film Containing Silver Nanowires and Manufacturing Method Thereof

(75) Inventors: Tsung-Ju HSU, Taichung City (TW); An-Ting KUO, New Taipei City (TW); Hou-Zen CHIANG, Taoyuan County (TW)

(73) Assignee: BENQ MATERIALS CORPORATION, Taoyuan County (TW)

(21) Appl. No.: 13/072,804

(22) Filed: Mar. 28, 2011

(30) Foreign Application Priority Data
Jan. 28, 2011 (TW) 100103351

(51) Int. Cl. H01B 1/22; B32B 27/04; B05D 5/12; B32B 15/02; B82Y 30/00

(52) U.S. Cl. 428/301.1; 427/125; 428/457; 428/349; 428/343; 428/423.1; 428/447; 428/335; 977/762; 977/932

(57) ABSTRACT

A flexible transparent conductive film is provided. The conductive film includes a hydrophilic transparent resin and silver nanowires distributed in the resin. A method for manufacturing the flexible transparent conductive film is also disclosed.

### RELATED APPLICATIONS

This application claims priority to Taiwan Application Serial Number 100103351, filed Jan. 28, 2011, which is herein incorporated by reference.

### BACKGROUND

1. Technical Field

The disclosure relates to a conductive film and a manufacturing method thereof. More particularly, the disclosure relates to a flexible transparent conductive film and a manufacturing method thereof.

2. Description of Related Art

Both display panels and solar cells need transparent conductive film. Common transparent conductive materials are some metal oxide materials, such as indium tin oxide. These metal oxides are not only high cost, but also too rigid to meet requirements of some flexible applications, such as electronic papers.

### SUMMARY

Accordingly, in one aspect, the present invention is directed to a flexible transparent conductive film and a manufacturing method thereof.

In one embodiment, the flexible transparent conductive film comprises a hydrophilic transparent resin and silver nanowires distributed therein.

According to another embodiment, the manufacturing method of the flexible transparent conductive film comprises the following step. First, a hydrophilic transparent resin is coated on a flexible transparent substrate and then dried. Next, the dried hydrophilic transparent resin is immersed in a dispersion solution of sliver nanowires. Finally, the hydrophilic transparent resin is thermocompressed to let the silver nanowires be compressed into the hydrophilic transparent resin. The immersing step and the thermocompressing step can be repeated for several times till the required surface resistance is met.

The forgoing presents a simplified summary of the disclosure in order to provide a basic understanding of the present invention. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

Many of the attendant features will be more readily appreciated as the same becomes better understood by reference to the following detailed description considered in connection with the accompanying drawings.

### BRIEF DESCRIPTION OF THE DRAWINGS

FIG. 1A is a cross-sectional view of a flexible transparent conductive film containing silver nanowires according to an embodiment of this invention.

FIG. 1B is a top view of the flexible transparent conductive film of FIG. 1A.

FIG. 2 is a flowchart of a method for manufacturing the flexible transparent conductive film containing silver nanowires of FIG. 1A.

### DETAILED DESCRIPTION

Accordingly, a flexible transparent conductive film and a manufacturing method thereof are provided. In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### Structure of a Flexible Transparent Conductive Film Containing Silver Nanowires

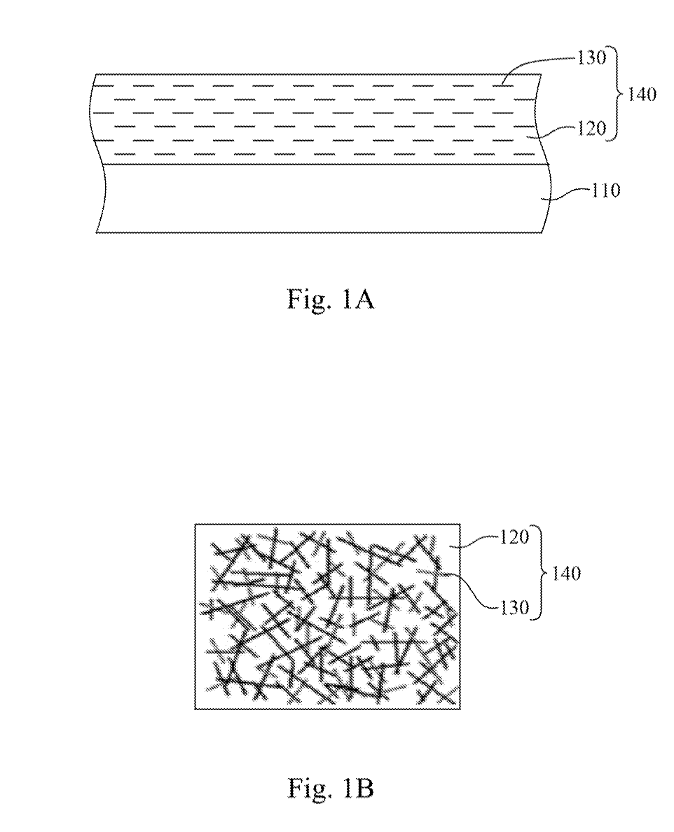

FIG. 1A is a cross-sectional view of a flexible transparent conductive film containing silver nanowires according to an embodiment of this invention. In FIG. 1A, the flexible transparent conductive film 140 containing silver nanowires is formed on a flexible transparent substrate 110. The flexible transparent conductive film 140 comprises a hydrophilic transparent resin 120 and silver nanowires 130 distributed therein.

FIG. 1B is a top view of the flexible transparent conductive film of FIG. 1A. It shows in FIG. 1B that the silver nanowires 130 are irregularly distributed in the transparent resin 120 to form a plurality of contacts therebetween. Thus, the conductivity of the flexible transparent conductive film 140 can be enhanced to meet the demand of the two-dimensional conductivity.

The flexible transparent substrate 110 can be for example, such as poly(ethylene terephthalate) (PET), polymethylmethacrylate (PMMA), or polycarbonate (PC).

The hydrophilic transparent resin 120 can be pressure sensitive adhesive or hot melt adhesive. The glass transition temperature of the pressure sensitive adhesive is lower than room temperature (about 25° C.). The pressure sensitive adhesive can be for example, such as acrylic resin, or polysilicone. The glass transition temperature of the hot melt adhesive is higher than room temperature (about 25° C.). The hot melt adhesive can be for example, such as polyurethane or acrylic resin.

The diameter of the silver nanowires 130 is preferably 70 nm to 120 nm and the length of the silver nanowires 130 is preferably 14 μm to 25 μm and the aspect ratio of the silver nanowires 130 is preferably 180 to 220.

The thickness of the flexible transparent conductive film 140 containing the hydrophilic resin 120 and the silver nanowires 130 is 20 μm to 70 μm, preferably 30 μm to 50 μm. In order to decrease the surface resistance of the transparent conductive film 140 no greater than indium tin oxide (ITO; about 400 ohm/cm²) and maintain the light transmittance of the transparent conductive film 140 at 60% to 80% (measured by Nippon Denshoku Corporation, Japan, NDH 2000 haze meter), the content of the silver nanowires 130 is 0.5 wt % to 4 wt %, preferably 2 wt % to 3 wt %.

### Manufacturing Method of Transparent Conductive Film

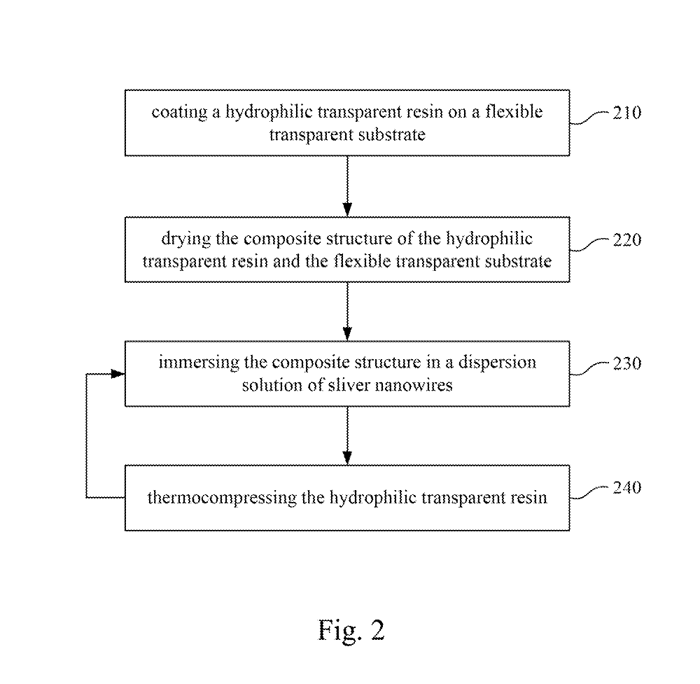

FIG. 2 is a flowchart of a method for manufacturing the flexible transparent conductive film containing silver nanowires of FIG. 1A. In FIG. 2, the manufacturing process comprises the steps of coating a hydrophilic transparent resin on a flexible transparent substrate (step 210), drying the composite structure of the hydrophilic transparent resin and the flexible transparent substrate (step 220), immersing the composite structure in a dispersion solution of sliver nanowires (step 230), and thermocompressing the hydrophilic transparent resin (step 240).

In step 210, a hydrophilic transparent resin is uniformly coated on a flexible transparent substrate. Then in step 220, the composite structure of the hydrophilic transparent resin and the flexible transparent substrate is dried. Drying method can be, for example, heating. The resulting composite structure can be dried in horizontally or vertically position.

In step 230, the composite structure obtained in step 220 is immersed in a dispersion solution of sliver nanowires to make the silver nanowires be adsorbed to the surface of the hydrophilic transparent resin by polar interaction (i.e. hydrophilic interaction). The solvent of the dispersion solution can be, such as water, ethanol, propanol, or any combinations thereof. The content of the silver nanowires in the dispersion solution is 0.05 wt % to 10 wt %, such as 0.1 wt % to 5 wt %, or 0.1 wt % to 1 wt %.

Next in step 240, the silver nanowires are compressed into the hydrophilic transparent resin by theromcompressing to form the flexible transparent conductive film. The silver nanowires in the hydrophilic transparent resin are in a content of 0.5 wt % to 4 wt %, preferably from 2 wt % to 3 wt %. Suitable temperature, pressure and time for manufacturing the flexible transparent conductive film depend on the material of the hydrophilic transparent resin. For example, the composite structure of the hydrophilic transparent resin and the flexible transparent substrate may be conveyed on a conveyor belt at a conveying rate of 0.45 m/min, the thermocompressing temperature can be 80° C. to 120° C., the pressure can be 1 atm to 5 atm, and the thermocompressing step needs to be repeated for no less than 2 times while the material of the hydrophilic transparent resin is acrylic resin.

Then, the immersing step 230 and the thermocompressing step 240 can be repeated for several times till the required surface resistance is met.

### Embodiment 1

### Influence of Immersing Times on Surface Resistance of the Flexible Transparent Conductive Film

In this embodiment, the flexible transparent substrate was polyethylene terephthalate) (commercial name was 0300E, from Mitsubishi, Japan). The hydrophilic transparent resin was acrylic resin (weight average molecular weight was 400,000 to 600,000, and glass transition temperature was 40° C. to 70° C.). The drying condition was vertically positioned the samples at a temperature of 85° C. for 10 minutes. The concentration of the silver nanowires dispersion solution was 0.46 wt %. The temperature and the pressure of the thermocompressing step were 110° C. and 2 atm, respectively. The obtained results are listed in Table 1.

It is shown in Table 1 that the surface resistance of the flexible transparent conductive film was decreased when the immersion times were increased. Moreover, the surface resistance was further decreased after standing for a few days. It presumes that the decreased surface resistance of the flexible transparent conductive film results from the densified hydrophilic transparent resin of the flexible transparent conductive film. Furthermore, the silver nanowires content of the flexible transparent conductive film is 2 wt % and the surface resistance of the flexible transparent conductive film (32 ohm/cm²) is much lower than the surface resistance of the indium tin oxide (400 ohm/cm²).

TABLE 1
influence of immersing times on the surface resistance of the
flexible transparent conductive film

| | | | Example 1 | Example 2 |
|---|---|---|---|---|
| Immersing | 1 | Surface resistance | nonconductive | nonconductive |
| times | 2 | (ohm/cm²) | 2.3 × 10⁶ | nonconductive |
| | 3 | | 2.3 × 10³ | 1.0 × 10⁶ |
| | 4 | | 170 | 1.6 × 10⁴ |
| | 5 | | — | 1.6 × 10³ |

| Standing for 4 days | | 32 | 32 |
|---|---|---|---|
| After | Film thickness (μm) | 150.7 | 154.0 |
| standing for | Transmittance (%) | 61 | 63 |
| 4 days | | | |

### Embodiment 2

### Influence of Dispersion Solution Concentration on Surface Resistance of the Flexible Transparent Conductive Film

In this embodiment, the flexible transparent substrate was poly(ethylene terephthalate) (commercial name was 0300E, from Mitsubishi, Japan). The hydrophilic transparent resin was acrylic resin (weight average molecular weight was 400,000-600,000, and glass transition temperature was 40° C.-70° C.). The drying condition was vertically hung at a temperature of 85° C. for 10 minutes. The temperature and the pressure of the thermocompressing step were 110° C. and 2 atm, respectively. The obtained results are listed in Table 2.

From Table 2, it shows that the smaller surface resistance can be obtained by a lower concentration of silver nanowires dispersion solution with more immersing times.

TABLE 2
influence of dispersion solution concentration on surface
resistance of the flexible transparent conductive film

| | | | | Surface | Film |
|---|---|---|---|---|---|
| | Silver nanowires | Immersion | Transmittance | resistance | thickness |
| Examples | concentration (wt %) | times | (%) | (ohm/cm²) | (μm) |
| 3 | 0.05 | 10 | 57 | 37 | 143.3 |
| 4 | 0.10 | 5 | 63 | 12 | 144.7 |
| 5 | 0.10 | 5 | 60 | 16 | 141.0 |

While the invention has been described by way of example(s) and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A flexible transparent conductive film, comprising:
a hydrophilic transparent resin on a flexible transparent substrate; and
silver nanowires distributed in the hydrophilic transparent resin, wherein diameter of the silver nanowires is smaller than 120 nm and the aspect ratio is 180 to 220, and the content of the silver nanowires in the hydrophilic transparent resin is 0.5 wt % to 4 wt %.

2. The flexible transparent conductive film of claim 1, wherein the hydrophilic transparent resin is a pressure sensitive adhesive or a hot melt adhesive.

3. The flexible transparent conductive film of claim 1, wherein the hydrophilic transparent resin is acrylic resin, polysilicone, or polyurethane.

4. The flexible transparent conductive film of claim 1, wherein a thickness of the hydrophilic transparent resin is 20 μm to 70 μm.

5-6. (canceled)

7. A method of manufacturing a flexible transparent conductive film, the method comprising:
coating a hydrophilic transparent resin on a flexible transparent substrate;
drying the hydrophilic transparent resin;
immersing the dried hydrophilic transparent resin in a dispersion solution of sliver nanowires;
thermocompressing the hydrophilic transparent resin to let the silver nanowires be compressed into the hydrophilic transparent resin; and
repeating the immersing step and the thermocompressing step for several times till the required surface resistance is meet.

8. The method of claim 7, wherein the material of the flexible transparent substrate is poly(ethylene terephthalate), polymethylmethacrylate, or polycarbonate.

9. The method of claim 7, wherein the hydrophilic transparent resin is a pressure sensitive adhesive or a hot melt adhesive.

10. The method of claim 7, wherein the hydrophilic transparent resin is acrylic resin, polysilicone, or polyurethane.

11. The method of claim 7, wherein a thickness of the hydrophilic transparent resin is 20 μm to 70 μm.

12. The method of claim 7, wherein diameter of the silver nanowires is smaller than 120 nm and the aspect ratio is 180 to 220.

13. The method of claim 7, wherein the content of the silver nanowires in the hydrophilic transparent resin is 0.5 wt % to 4 wt %.

14. The method of claim 7, wherein the solvent of the dispersion solution is water, ethanol, propanol, or any combinations thereof.
